(19) United States
(12) Patent Application Publication
(10) Pub. No.: US 2007/0184152 A1
(43) Pub. Date: Aug. 9, 2007

(54) Fortified soft drink for hangover relief

(76) Inventors: Thomas Pemble, Peoria, IL (US); Timothy Hamblin, Dunlap, IL (US); Jill Donahue, Brimfield, IL (US); James Richmond, Peoria, IL (US); Scott Miller, Peoria, IL (US)

Correspondence Address: Clifford H. Kraft;Suite 274, 27 N. Wacker Dr., Chicago, IL, 60606, US

(21) Appl. No.: 11/347,762

(22) Filed: Feb. 3, 2006

(51) Int. Cl. A23L 1/30

(52) U.S. Cl. 426/72

(57) ABSTRACT

A soft drink and method of producing a soft drink that is a fortified, normally zero calorie beverage, formulated with natural flavors such as lemon or berry that can be formulated from L-Gluamine, sodium bicarbonate, a potassium salt like potassium chloride or potassium gluconate, caffeine with optional B vitamins, folic acid and vitamin C added for fortification along with a sweetener. This drink mixture can help reduce or eliminate symptoms of a hangover caused by alcohol consumption as well as supply a large portion of the recommended daily requirements for some vitamins and minerals.

### FIELD OF THE INVENTION

The present invention relates generally to the field of soft drinks and more particularly to a fortified, zero calorie beverage that aids with hangover relief.

### DESCRIPTION OF THE PRIOR ART

It is known to take various medications and preparations to help with the symptoms caused by alcohol consumption normally called a hangover. The symptoms usually take the form of a headache, possible nausea, stiffness and a general feeling of fatigue and un-wellness.

Commonly taken drugs and preparations can include aspirin, acetaminophen, bromo- or lemon-carbonated water, coffee and many, many more. In general, these preparations only provide partial relief.

While there may be no total relief from a hangover, it would be advantageous to have a fortified drink that was nutritious and contained ingredients that help relieve the symptoms.

### SUMMARY OF THE INVENTION

The present invention relates to a mixture of ingredients and vitamins that produce a pleasant-tasting soft drink that is nutritious and that can aid in relief of hangover symptoms.

One object of the invention is a soft drink that is fortified with various vitamins and minerals.

Another object of the invention is a soft drink that contains at least 25% of the recommended daily allowance (RDA) of B vitamins, vitamin C and folic acid.

Another object of the invention is a soft drink that helps relive the effects of a hangover.

Another object of the invention is a soft drink that supplies a portion of the recommended daily requirement of potassium.

### DESCRIPTION OF THE INVENTION

The present invention relates to a soft drink that helps relieve hangovers and provides a substantial part of the daily requirement of certain vitamins.

The drink is generally sweet tasting and can contain caffeine to provide a mild stimulant effect. The sweet taste can come from sugar; however, the preferred method is to use an artificial sweetener such Sucralose or Acesulfame to achieve a zero calorie drink. The freshness of the drink can be optionally preserved by addition of a sufficient quantity of sodium benzoate and/or potassium sorbate or any other preservative.

An example formulation of an embodiment of the present invention is as follows:

| | |
|---|---|
| L-Gluamine | 200 mg/8 oz serving |
| Sodium Bicarbonate | 1% |
| Potassium Chloride | 1% |
| Caffeine | 50 ppm (up to 200 ppm) |
| Water | sufficient to mix |

Additional, optional vitamins can be added as follows for an 8 oz drink:

| | |
|---|---|
| Vitamin C | 50% RDA |
| Vitamin B3 (Niacin) | 25% RDA |
| Vitamin B6 | 25% RDA |
| Vitamin B12 | 25% RDA |
| Folic Acid | 25% RDA |

Finally flavoring, coloring and preservatives can be added as is known in the art.

It should be noted that the proportions of the ingredients may be varied over a large range. For example, from 0-100% of the RDA vitamin requirement may be used for any vitamin or mineral. In addition, other vitamins and minerals my be optionally added. Various flavors such as lemon, a hint of lemon, berry or other flavors can also be incorporated into the drink to enhance its taste and attractiveness. Approved food coloring may be used to create a desirable color as is known in the art. It is also possible to substitute potassium gluconate for potassium chloride or to use other potassium salts.

L-Glutamine is an amino acid that helps the cells by converting into glucose by the brain. It also helps in protein synthesis and builds and maintains muscles. It can be used from around 30 mg to over 300 mg per 8 oz serving. B vitamins help maintain normal nervous system function, muscles and heart and help decrease tiredness while increasing appetite and alertness. Sodium bicarbonate is an antacid that also helps give a source of sodium to help retain water and reduce the dehydration that is common after consuming alcohol as well as neutralize acid a sooth the stomach. Folic acid, along with vitamins B6 and B12 support the body's synthesis lipotropic factors to keep homocysteine at a healthy level. Healthy homocysteine levels promote normal blood vessel dilation and proper circulation. Potassium from potassium salts is very important in cellular biochemical reactions and energy metabolism. Potassium also functions in carbohydrate metabolism and is active in glycogen and glucose metabolism. Potassium is important for normal growth and for building muscle, especially cardiac muscle. The RDA of potassium is around 2000-3000 mg. Caffeine is a stimulant that helps the body wake up and feel more alert. It can optionally be used in amounts from less than 25 ppm to around 200 parts per million (ppm) per 8 oz serving.

A typical embodiment of the present invention thus includes a mixture of L-Gluamine, Sodium Bicarbonate, a Potassium salt, Caffeine, Vitamin C, Vitamins B3, B6 and B12, Folic Acid, Lemon or Berry flavoring, Sucralose and/or Acesulfame Potassium or other sweetener, and Sodium Benzoate and/or Potassium Sorbate in aqueous solution.

Several descriptions and illustrations have been presented to better aid in the understanding of the present invention. One skilled in the art will realize that numerous changes, additions and variations may be made in keeping with the spirit of the invention. Each of these changes and variations is within the scope of the present invention.

We claim:

1. A soft drink useful for partially relieving hangover effects comprising L-gluamine, sodium bicarbonate, a potassium salt, caffeine, and water.

2. The soft drink of claim 1 further comprising at least one member chosen from the group consisting of vitamin C, vitamin B3, vitamin B6, vitamin B12 and folic acid.

3. The soft drink of claim 1 further comprising a sweetener.

4. The soft drink of claim 1 further comprising flavoring.

5. The soft drink of claim 4 wherein said flavoring is lemon or berry.

6. The soft drink of claim 3 wherein said sweetener is sucralose, acesulfame potassium or sugar.

7. A soft drink containing water, flavoring and around 200 mg/8 oz L-gluamine, around 1% sodium bicarbonate, around 1% potassium chloride or potassium gluconate and from around 25-200 ppm caffeine.

8. The soft drink of claim 7 further containing at least one or more members of the group consisting of vitamin C, vitamin B3, vitamin B6, vitamin B12 and folic acid.

9. The soft drink of claim 8 wherein the member is around 50% RDA vitamin C.

10. The soft drink of claim 8 wherein the member is around 25% RDA of at least one of said B vitamins.

11. The soft drink of claim 8 wherein the member is around 25% RDA of folic acid.

12. The soft drink of claim 7 further comprising a sweetener.

13. The soft drink of claim 12 wherein the sweetener is chosen from the group consisting of sucralose, acesulfame potassium and sugar.

14. The soft drink of claim 7 further comprising a preservative.

15. The soft drink of claim 14 wherein the preservative is chosen from the group consisting of sodium benzoate and potassium sorbate.

16. A method of producing a soft drink that helps relieve symptoms of a hangover comprising the steps of mixing in water an amount per 8 oz serving of:
from 25-300 mg L-Gluamine;
around 1% sodium bicarbonate;
around 1% potassium chloride or potassium gluconate;
around 25-300 ppm caffeine
a sufficient amount of flavoring for taste;
a sufficient amount of sweetener to achieve a sweet taste.

17. The method of claim 16 further comprising the step of mixing per 8 oz serving:
around 25% RDA of at least one member of the group consisting of vitamin C, vitamin B3, vitamin B6, vitamin B12 and folic acid.

18. The method of claim 16 further comprising the step of mixing per 8 oz serving a sufficient amount of preservative.

19. The method of claim 18 wherein said preservative is sodium benzoate or potassium sorbate.

20. The method of claim 16 wherein said sweetener is sucralose, acesulfame potassium or sugar.
